(19) United States
(12) Patent Application Publication
(10) Pub. No.: US 2007/0036275 A1
(43) Pub. Date: Feb. 15, 2007

(54) Protocol tester for a telecommunication system and method for presenting transmission-relevant information relating to a telecommunication system

(76) Inventors: Michael Bluemche, Berlin (DE); Christian Zander, Berlin (DE)

Correspondence Address: MATTHEW D. RABDAU;TEKTRONIX, INC., 14150 S.W. KARL BRAUN DRIVE, P.O. BOX 500 (50-LAW), BEAVERTON, OR, 97077-0001, US

(21) Appl. No.: 11/349,598

(22) Filed: Feb. 8, 2006

(30) Foreign Application Priority Data
Feb. 8, 2005 (EP) 05002600.4

(51) Int. Cl. H04M 1/24

(52) U.S. Cl. 379/1.01

(57) ABSTRACT

The present invention relates to a protocol tester for a telecommunication system, whereby the protocol tester (10) exhibits a display unit and a control unit (22), which is connected to the display unit (20) to transmit transmission-relevant information to the display unit for display on the display unit, and whereby the transmission-relevant information is classifiable according to at least three transmission parameters, whereby the control unit (22) is designed to make the transmission-relevant information available to the display unit (20) so that it is presentable on the display unit (20) in the form of a two-dimensional multi-variant chart, whereby the multi-variant chart exhibits a number of axes, which corresponds at least to the number of the transmission parameters, and whereby the values of the transmission parameters are plottable along the axes of the multi-variant chart. It also relates to a method for presenting transmission-relevant information relating to a telecommunication system on a protocol tester, which exhibits a display unit, whereby the transmission-relevant information is classifiable according to at least three transmission parameters, comprising the following step: Presentation of the transmission-relevant information in the form of a two-dimensional multi-variant chart on the display unit in such a way that the multi-variant chart exhibits a number of axes, which corresponds at least to the number of transmission parameters, and whereby the values of the transmission parameters are plotted along the axes of the multi-variant chart.

### BACKGROUND

The present invention relates to a protocol tester for a telecommunication system, whereby the protocol tester exhibits a display unit and a control unit, which is connected to the display unit in order to transfer transmission-relevant information to the display unit for display on the display unit, and whereby the transmission-relevant information is classifiable according to at least three transmission parameters. It also relates to a method for presenting transmission-relevant information relating to a telecommunication system on a protocol tester, which exhibits a display unit, whereby the transmission-relevant information is classifiable according to at least three transmission parameters.

In data transmission via a telecommunication system, there are a multitude of transmission parameters that are of relevance, with different institutions being interested in different transmission parameters. The manufacturer of a network element of the telecommunication system is, for example, interested in his network element being capable of processing certain transmission rates of different data transmission formats. This characteristic can be determined, for example, in advance, i.e. prior to the installation of the network element into a real telecommunication system, as part of a load test in which the network element is connected to a virtual telecommunication system and subjected to corresponding tests. A network operator on the other hand is interested in monitoring certain network elements during operation in order to detect weak points, i.e. bottlenecks in his network, so as to be able in this way to take countermeasures in time. It is possible, for example, to detect the overload of a certain network element and to replace said network element by a higher-capacity network element, or by two network elements. After all, both of the institutions named as examples—network element manufacturers and network operators—are interested in statistically recording the quality of the network element on the one hand, and of the network on the other hand. What is problematic is the large number of the transmission parameters that are of interest in each case. In prior art, the relevant values of the transmission parameters are shown in the form of bar charts, in which the individual transmission parameters are plotted independently of each other. There are particularly two constellations in which the complexity and the recording difficulties resulting therefrom have an especially negative effect: On the one hand, there are, for example, mobile protocol testers, which are used in monitoring a telecommunication network, for which no possibility has been envisaged to locally prepare prints for the purpose of comparing diagrams of the relevant transmission parameters. On the other hand it is often the case that the current values of the transmission parameters are to be compared against requirements, such as a standard or a specification, which, in prior art, results in an even less clearly arranged representation. Moreover, for the procedure according to prior art, the individual transmission parameters cannot be related to each other, e.g. by addition. If, as part of a load test, for example, transmission parameters are defined for the load test, particularly a load test relating to the transmission rate, which differ depending on the type of the data transmitted, then according to prior art, a measure for the total load, i.e. the total transmission rate, can only be determined by adding the individual evaluated transmission parameters for the individual transmission rates.

This results in the definition of unsuitable tests, in misinterpretations of the quality of network elements and networks, and eventually in the risk of irrecoverable data loss.

What are desired is a protocol tester and/or a method to be able to reduce the loss of data during data transmission in a telecommunication system.

### SUMMARY

Embodiments of the present invention are based on the realization that an improvement of the prior art can be accomplished by significantly increasing the clarity of the transmission parameters shown, if the representation is made in a multi-variant chart whose axes are formed by the transmission parameters. Given that the axes of a multi-variant chart intersect in a point, the individual transmission parameters can be positioned in direct relation to, and compared with, each other much more easily than if two transmission parameters are to be compared with each other across different bars of a bar chart, which are less relevant for the assessment.

In an embodiment of the present invention, the transmission-relevant information is realized through load-related data, the transmission parameters are realized through load test parameters, and the protocol tester is realized through a load test appliance.

Another embodiment is characterized in that the values of the at least three transmission parameters, which have each been entered into the multi-variant chart, are connected with each other to form an area. If this method is applied in a load test, then the area shown, which can be assessed in terms of its size right away without any intermediate steps, is a measure of the total load that is allowed to act upon the network element as part of said load test.

Another embodiment is characterized using several sets of values of the transmission parameters, whereby a first area corresponds to a first set of values of the transmission parameters, and an i^{th} area corresponds to an i^{th} set of values of the transmission parameters. In a load test, for example, an area can show the load expected for this network element at the position in the telecommunication network, while another area characterizes the load currently specified for the load test. During monitoring, which will be addressed in more detail below, the different areas can show the transmission parameters at different points in time. As part of the visualization of measurements performed, which will also be addressed in more detail below, one area can show the thresholds of a requirement or standard, while the other area renders the measured values actually measured.

The areas are preferably shown at the same time, whereby it is possible to show the two or more areas in a transparent manner for them to be more recognizable, or to show a difference between two or more areas.

In view of the fact that in today's standards for telecommunication networks such as GSM, GPRS and UMTS, data transmission is subdivided into control plane data and user plane data, the transmission-relevant information can be realized through control plane data and/or user plane data.

With regard to a simple comparison with a requirement such as thresholds of standards or requirements in specifications, it is especially preferred if the parts of an area, which area located within specifiable limits, and/or parts of an area, which are close to specifiable limits, and/or parts of an area, which are outside specifiable limits, are shown differently, particularly by a different color. This way defects can be recognized and countermeasures taken immediately.

In another embodiment, there is provided on the display unit a graphical user interface, whereby it is possible for the values of the transmission parameters to be manipulated graphically, particularly through the use of an indicator unit such as a computer mouse. In a load test, for example, the test parameters can be modified this way in a very simple fashion; a reconciliation of the individual transmission parameters can be effected in a fast and easy manner. This way, transmission parameter thresholds can quickly be entered into the system and existing values changed.

The values of the transmission parameters are preferably used for monitoring the transmission parameters of a transmission under way, particularly the test parameters of a load test under way, whereby the readings of the transmission parameter values preferably are updated at specifiable intervals. The reading on the display unit practically pulsates in the rhythm of the updates. It may be envisaged to have representations stored in a storage device for subsequent evaluation, particularly those where a specifiable threshold was exceeded, or at the press of a button on an entry device.

Another embodiment is characterized in that the transmission parameters of a completed measurement, particularly the measured values of the transmission parameters of a completed load test, are visualized through the values of the transmission parameters.

In the following, embodiments of the present invention will be described in more detail with reference to the drawings attached.

### BRIEF DESCRIPTION OF THE DRAWINGS:

FIG. 1 is a schematic representation of an embodiment of a protocol tester according to the present invention.

FIG. 2a is an example representation on the display unit for the definition of a load test relating to the user plane.

FIG. 2b is an example representation on the display unit for the definition of a load test relating to the control plane.

FIG. 3a is an example representation on the display unit for the monitoring of the load on the user plane, where the monitored load does not exceed the limits of the expected load.

FIG. 3b is an example representation on the display unit for the monitoring of the load on the user plane, where the monitored load exceeds the limits of the expected load for two transmission parameters, however, the total area of the monitored load is still smaller than the total area of the expected load.

FIG. 3c is an example representation on the display unit for the monitoring of the load on the user plane, where the monitored load exceeds the limits of the expected load for four transmission parameters, however, the total area of the monitored load exceeds the total area of the expected load.

FIG. 4a is an example representation on the display unit after a measurement for the visualization of the control plane parameters, where on the one hand there is shown an area that is formed by the specified thresholds, while on the other hand there is shown an area that is formed by the measured values of the current measurement, and the area that results from the current measurement values covers up the area based on the thresholds.

FIG. 4b is an example representation on the display unit after a measurement for the visualization of the user plane parameters, where on the one hand there is shown an area that is formed by the specified thresholds, while on the other hand there is shown an area that is formed by the measured values of the current measurement;

FIG. 4c is an example representation on the display unit after a measurement for the visualization of the user plane parameters, where on the one hand there is shown an area that is formed by the specified thresholds, while on the other hand there is shown an area that is formed by the measured values of the current measurement, and the threshold area is shown in a transparent manner;

FIG. 4d is an example representation on the display unit after a measurement for the visualization of the user plane parameters, where on the one hand there is shown an area that is formed by the specified thresholds, while on the other hand there is shown an area that is formed by the measured values of the current measurement, and the difference of the two areas is shown.

### DESCRIPTION

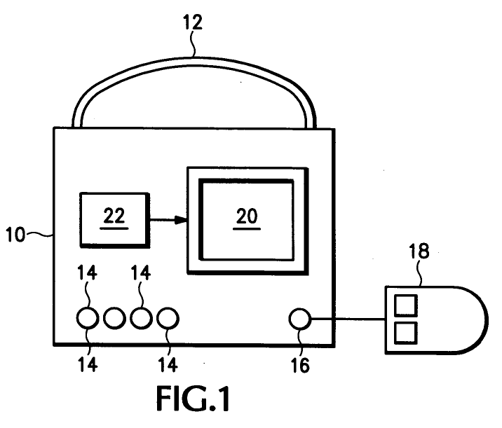

FIG. 1 shows a protocol tester 10 according to the present invention having a carrier handle 12. On the protocol tester there are provided a multitude of ports 14 to connect the protocol tester to at least one network element or to a telecommunication network. Via a port 16, a computer mouse 18 is connectable to the protocol tester 10. The protocol tester 10 exhibits a display unit 20 and a control unit 22, which is connected to the display unit 20 to transfer transmission-relevant information to the display unit 20 for display on the display unit 20. The transmission-relevant information is classifiable according to at least three transmission parameters. The control unit 22 is designed to make the transmission-relevant information available to the display unit 20, so that it is presentable on the display unit 20 in the form of a two-dimensional multi-variant chart, whereby the multi-variant chart exhibits a number of axes, which corresponds at least to the number of transmission parameters, and whereby the values of the transmission parameters are plonable along the axes of the multi-variant chart.

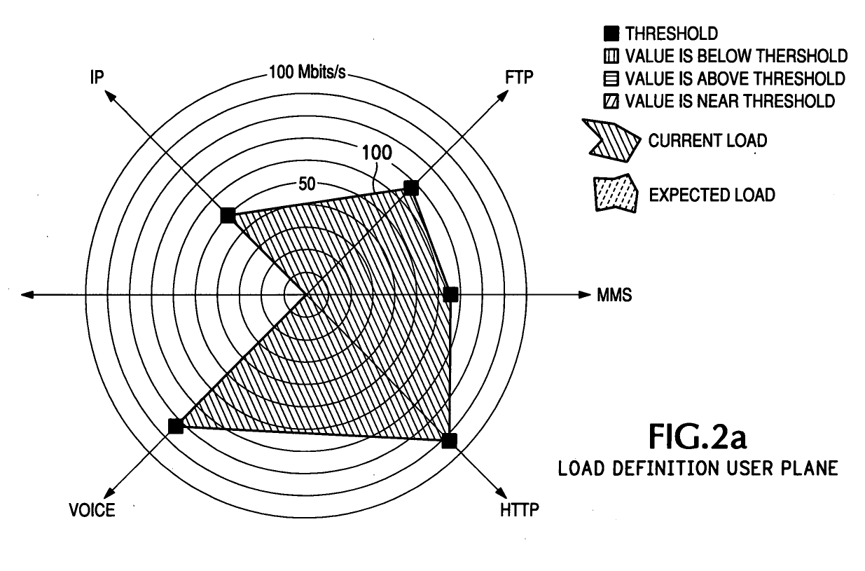

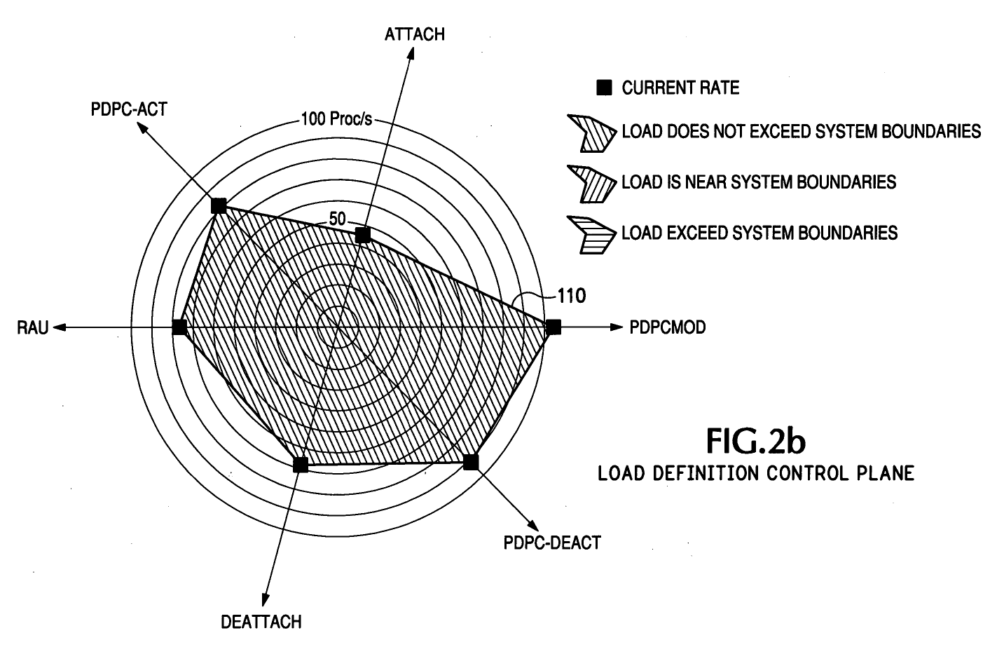

FIG. 2a shows as an example of a representation on the display unit for the definition of a load test of the user plane. As shown, the multi-variant chart comprises six axes, only five of which are assigned transmission parameters. The axes of the transmission parameters intersect in a point around which there are arranged circles that correspond to increasing transmission rates. The five transmission parameters correspond to different formats of the data transmitted, in this case VOICE, HTTP, MMS, FTP and IP. The different transmission parameter values entered, which are represented by small squares, can be moved around using the mouse 18, or be modified via a separate entry mask. In the case shown, the values have been placed on the thresholds of the expected loads so that the two areas of the set load on the one hand and of the expected load on the other hand are congruent. The graph of the load currently set is displayed as an area 100, which may be presented in a first color, e.g. green, while the graph of the expected load is presented in a second color, e.g. grey. In one embodiment, the load currently set as displayed overlies the expected load and is opaque so that the expected load is not discernable, as shown in FIG. 2a.

FIG. 2b shows a representation that corresponds to FIG. 2a for the definition of a load test of the user plane. The concentric circles correspond to events per unit of time. In the case shown as an example, there are six transmission parameters, namely ATTACH, PDPC-ACT, RAU, DEATTACH, PDPC-DEACT and PDPCMOD. The area 110 currently resulting from the definition of the transmission parameters lies inside the system limits and is therefore displayed in a-first color, e.g. green.

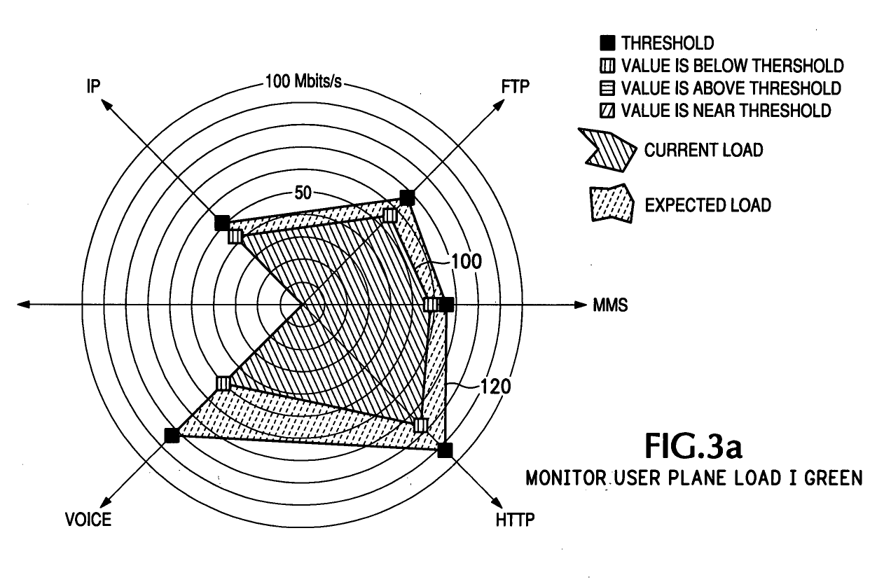

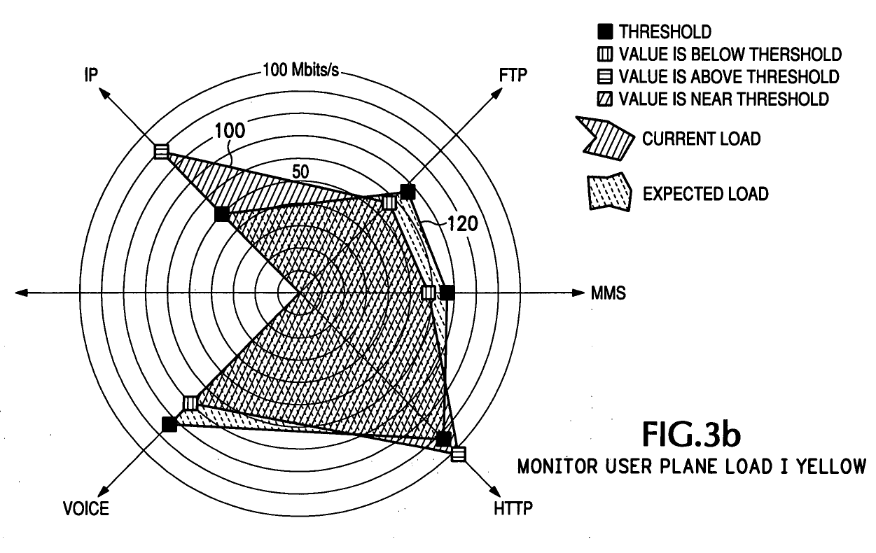

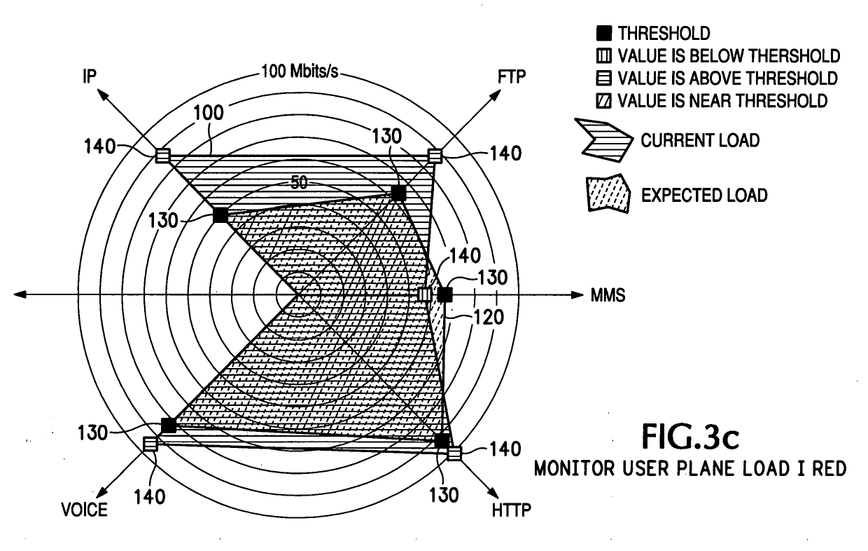

FIG. 3a shows as an example the representation on the display unit for the monitoring of the user plane during a load test with the transmission parameters already known from FIG. 2a. In this case, there are two areas, one area 100 resulting from the monitored values of the transmission parameters, and a second area 120 resulting from the values of the transmission parameters for the expected load. Since the monitored values of the transmission parameters are consistently smaller than the values of the transmission parameters of the load to be expected, the area resulting from the monitored values lies inside the area resulting from the values of the expected loads, and may be displayed in a first color, e.g. green. The area 120 corresponding to the expected load may be displayed in a second color, e.g. grey.

FIG. 3b shows the representation of FIG. 3a, whereby the monitored values in two transmission parameters are greater than the corresponding values of the expected load. However, the area, 100 resulting from the monitoring is still smaller than the area of the expected load 120. The area resulting from the monitoring may be displayed in a third color, e.g. yellow.

FIG. 3c shows the representation of FIGS. 3a and 3b, this time, however, with four monitored values greater than the corresponding values of the transmission parameters of the expected load. Moreover, the total area resulting from the monitored values is larger than the total area resulting from the expected load. The area 100 resulting from the monitored values is displayed in a fourth color, e.g. red.

For the entered thresholds or monitored values, which have been entered as small squares, there is a similar color code as for the areas shown in FIGS. 3a to 3c: The specified values 130 of the expected load, are highlighted in a fifth color, e.g. blue. If the monitored value 140 is smaller than the expected value, the corresponding square 140 may be green, for example, and if the monitored value is greater than the expected value, the corresponding square may be red, for example. If the monitored value is near the expected value, the corresponding square may be yellow, for example.

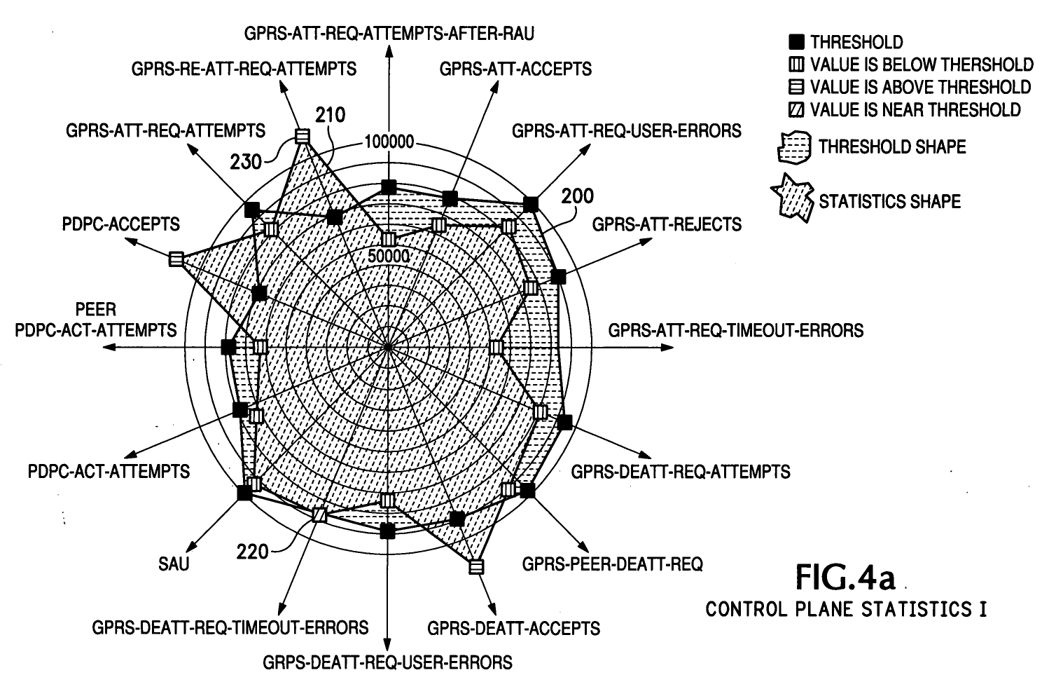

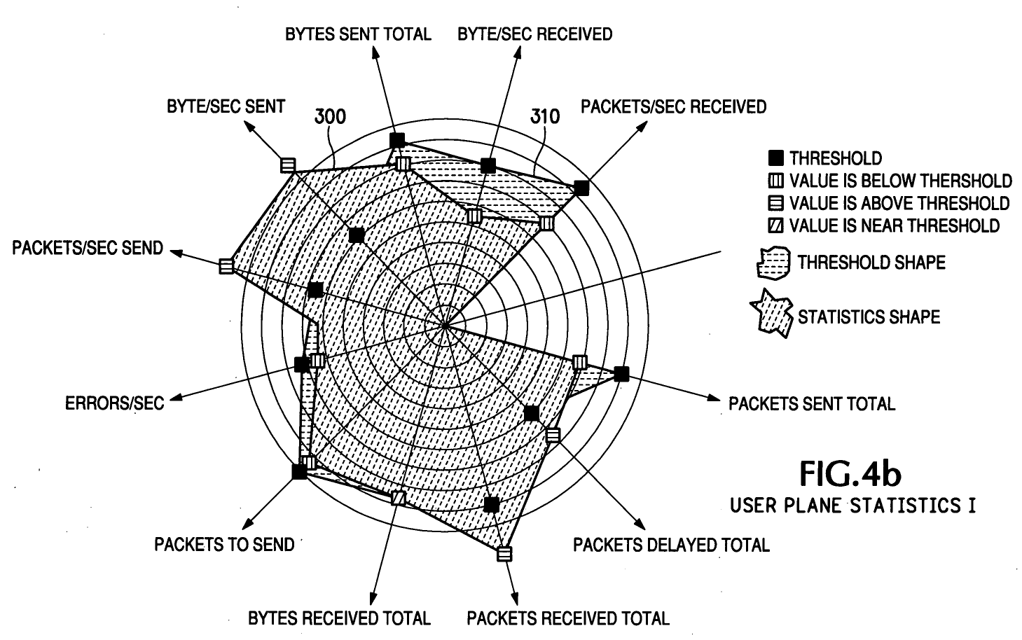

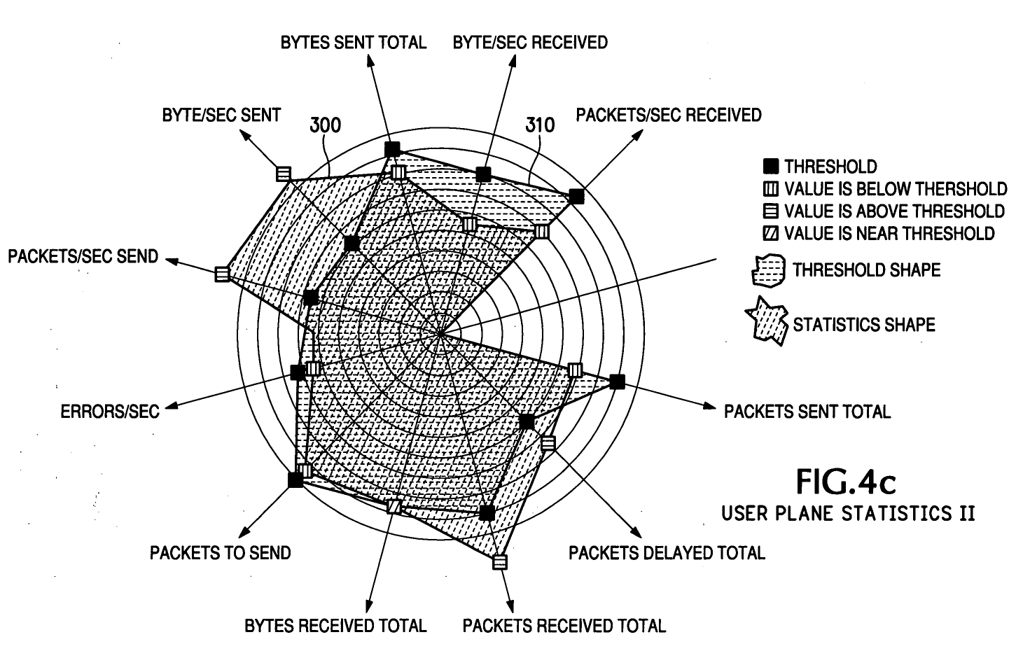

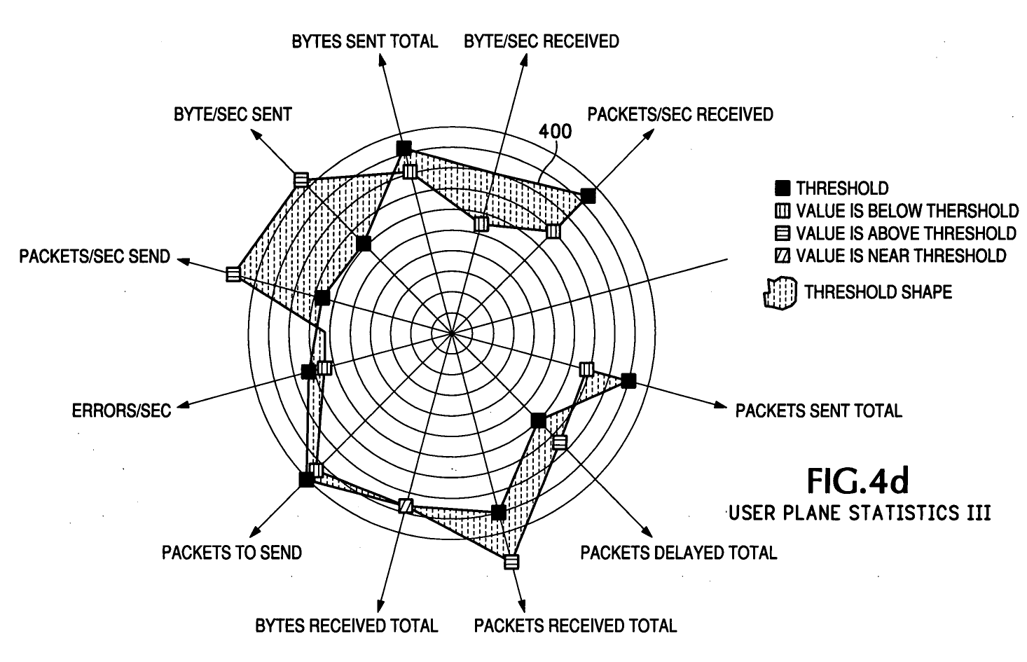

FIG. 4a shows, as an example, the representation on the display unit during the visualization of the results relating to the control plane, whereby the circles of an increasing radius correspond to an increasing number of events characterized by the transmission parameters. The results may have been determined by way of a test, or on the basis of a measurement on a real network or network element. The multi-variant chart shows 16 different transmission parameters, whereby two areas have been formed: an area 200 resulting from specified thresholds for the 16 transmission parameters, and an area 210 resulting from the measured values for the transmission parameters. The area 210 resulting from the measured values covers up the area 200 resulting from the specified thresholds. According to the color code described in connection with FIG. 3c, the value of a transmission parameter, which is located in the vicinity of a specifiable threshold of the same transmission parameter, may be shown using a block 220, or other shape, in another color, e.g. yellow. If the value of a transmission parameter exceeds a specified threshold, a block 230 may be in yet another color, e.g. red. The transmission parameters shown as examples in the figures will be known to the person skilled in the field of telecommunication engineering, and as the type of the transmission parameters is of no relevance to the invention itself, it is not referred to in more detail here.

FIG. 4b shows as an example the representation on the display unit, which corresponds to that of FIG. 4a, the difference being that in FIG. 4b there are plotted transmission parameters relating to the user plane. In FIG. 4b an area 300 resulting from the measured values of the transmission parameters covers up an area 310 resulting from the specified thresholds of the transmission parameters.

In FIG. 4c, the area resulting from the specifiable thresholds is shown in a transparent manner so that both areas can be presented simultaneously on the display unit.

FIG. 4d corresponds to the representation of FIG. 4c where an area 400 is shown which corresponds to the differences between the area 300 resulting from the measured values of the transmission parameter and the area 310 resulting from the specified thresholds of the transmission parameters. As shown, the area 400 corresponds to the area where the area 310 and the area 300 do not overlap.

In another embodiment not shown, a positive difference can be shown in a first color, and a negative difference can be shown in a second color. So that where the area 300 extends beyond the area 310, the area would be shown in one color, for example red for areas exceeding a threshold. Where the area 300 is within the area 310, the difference may be shown in another color, for example green, for areas where the threshold has not yet been reached.

Instead of the different colors mentioned in the application, it is possible to use different levels of brightness or, for monochrome presentations, different shades of grey or hatching patterns.

1. Protocol tester for a telecommunication system comprising:
a display unit presenting transmission-relevant information;
and a control unit connected to the display unit, to transmit transmission-relevant information to the display unit for display on the display unit, wherein the transmission-relevant information is classifiable according to at least three transmission parameters, and is presented as a two-dimensional multi-variant chart, wherein the multi-variant chart exhibits a number of axes corresponding to at least to the number of transmission parameters, and the values of the transmission parameters are plottable along the axes of the multi-variant chart.

2. A method for presenting transmission-relevant information relating to a telecommunication system on a protocol tester, comprising:
obtaining transmission-relevant information classifiable according to at least three transmission parameters; and
presenting the transmission-relevant information on a display unit in the form of a two-dimensional multi-variant chart on the display unit in such a way that the multi-variant chart exhibits a number of axes, which corresponds to at least the number of transmission parameters, and whereby the values of the transmission parameters are plotted along the axes of the multi-variant chart.

3. The method according to claim 2, wherein the transmission-relevant information is obtained through load test-related data, the transmission parameters are realized through load test parameters and the protocol tester is realized through a load test appliance.

4. The method according to claims 2, wherein the values of the at least three transmission parameters, which are each presented on the multi-variant chart, are connected with each other to form an area.

5. The method according to claims 3, wherein the values of the at least three transmission parameters, which are each presented on the multi-variant chart, are connected with each other to form an area.

6. The method according to claim 4, wherein a first area corresponds to a first set of values of the transmission parameters, and a second area corresponds to a second set of values of the transmission parameters.

7. The method according to claim 6, wherein the first area and the second area areas are presented simultaneously.

8. The method according to claim 6, wherein the difference between the first area and the second area is shown.

9. The method according to claim 2, wherein the transmission-relevant information is realized using control plane data or user plane data.

10. The method according to claims 2, wherein parts of an area located within specifiable thresholds are indicated using a first representation, parts of an area located in the vicinity of specifiable thresholds are indicated using a second representation, and parts of an area located outside specifiable 5 thresholds are shown using a third representation.

11. The method according to claim 10, wherein the first representation is a first color, the second representation is a second color, and the third representation is a third color.

12. The method according to claim 2, wherein on the display unit there is provided a graphical user interface, whereby the values of the transmission parameters are manipulated graphically.

13. The method according to claim 2, wherein the values of the transmission parameters are used for monitoring the transmission parameters of a transmission under way.

14. The method according to claim 13, wherein the reading of the transmission parameter values is updated at specifiable intervals.

15. The method according to claim 13, wherein the transmission parameters of a completed measurement are displayed based upon the values of the transmission parameters.
